(19) United States
(12) Patent Application Publication
(10) Pub. No.: US 2006/0153747 A1
(43) Pub. Date: Jul. 13, 2006

(54) Gas treatment adsorption-oxidation system

(75) Inventors: Joseph J. Sangiovanni, West Suffield, CT (US); Norberto O. Lemcoff, Simsbury, CT (US)

Correspondence Address: CARLSON, GASKEY & OLDS, P.C., 400 WEST MAPLE ROAD, SUITE 350, BIRMINGHAM, MI, 48009, US

(73) Assignee: Carrier Corporation

(21) Appl. No.: 11/035,378

(22) Filed: Jan. 13, 2005

(51) Int. Cl. B01D 50/00

(52) U.S. Cl. 422/169

(57) ABSTRACT

A gas treatment module and method includes a first gas purifier and a second gas purifier that cooperate to control a concentration of contaminants in an outgoing portion of a gas stream when the concentration of the contaminants in an incoming portion of the gas stream temporarily exceeds a threshold concentration. One example gas treatment module includes an adsorbent media that temporarily retains at least a portion of the contaminants in the gas stream when the concentration is greater than or equal to the threshold concentration. The adsorbent media later releases the retained contaminants, either to an outgoing portion of the gas stream or to a photocatalyst, when the concentration is less than the threshold concentration. One example method of gas treatment includes controlling the concentration of contaminants in the outgoing portion of the gas stream when the concentration of the contaminants in the incoming portion of the gas stream temporarily exceeds the threshold concentration.

### BACKGROUND OF THE INVENTION

This invention relates to air treatment modules and, more particularly, to an air treatment module having two gas-purifiers that cooperatively control a concentration of contaminants in an outgoing gas stream from the air treatment module.

Air treatment modules are commonly used in automotive, commercial and residential heating, ventilating, and air conditioning (HVAC) systems to purify a circulating gas stream. A typical air treatment module utilizes an air purifier to remove contaminants such as volatile organic compounds (VOCs) from the circulating gas stream. The air purifier typically includes one of a filter, adsorbent media, photocatalyst, plasma reactor, or other means that removes, treats, decontaminates, or chemically converts the contaminants, for example.

As the inventors discovered experimentally, known air purifiers may be unable to adequately control a VOC concentration in the circulating gas stream when the VOC concentration coming into the air purifier is temporarily above a normal VOC concentration. Temporary above-normal concentrations of VOCs may occur, for example, when certain foods or beverages are present, when an alcohol-based hand wipe is used, or when a VOC-containing product is spilled.

Known air purifiers are capable of removing or treating normal VOC concentration levels (i.e., non-excessive amounts of foods or beverages are present, when no or few alcohol-based hand wipes are being used, and in the absence of a spill) and may not completely treat the circulating air stream with above-normal VOC concentrations. An adsorbent media, for example, may not adsorb the VOCs rapidly enough to keep pace with the source rate of the VOCs. Likewise, a photocatalyst may be unable to capture and completely chemically convert the VOCs rapidly enough to keep pace with the source rate of the VOCs. As a result, the VOCs may either remain in the circulating gas stream in above-normal VOC concentrations or may be converted to equally undesirable intermediate VOC products. The VOCs and/or intermediate VOC products may then continue to contribute to odors or other undesirable conditions in the circulating gas stream.

It has been proposed to design larger capacity air purifiers, such as an adsorbent media having additional adsorption sites or a photocatalyst capable of more rapidly capturing and treating VOCs, however, these designs may require a large increase in the size and expense of the air purifier.

It is desirable to design and develop a more effective and economic air treatment module that controls the concentration of contaminants in the circulating gas stream during above-normal VOC concentrations.

### SUMMARY OF THE INVENTION

A gas treatment module includes first and second gas purifiers that cooperate to control a concentration of contaminants in an outgoing portion of a gas stream when the concentration of the contaminants in an incoming portion of the gas stream is temporarily equal to or greater than a threshold concentration. In one example, the first and second gas purifiers maintain the concentration of contaminants in the outgoing portion within a selected concentration range, although each of the first or second gas purifiers alone is unable to maintain the concentration within the selected concentration range.

Another example includes an adsorbent media that adsorbs and desorbs contaminants in the gas stream, depending on the concentration of contaminants in the gas stream. The adsorbent media predominantly adsorbs contaminants when the concentration is greater than or equal to the threshold concentration. When the concentration falls below the threshold concentration, the adsorbent media predominantly desorbs contaminants either to the outgoing portion of the gas stream or to a photocatalyst.

An example method of gas treatment includes controlling the concentration of contaminants in the outgoing portion of the gas stream when the concentration of the contaminants in the incoming portion of the gas stream temporarily exceeds the threshold concentration.

The various features and advantages of this invention will become apparent to those skilled in the art from the following detailed description of the currently preferred embodiment. The drawings that accompany the detailed description can be briefly described as follows.

### BRIEF DESCRIPTION OF THE DRAWINGS

FIG. 1 is a schematic cross-sectional view of an example structure that includes a heating, ventilating, and air conditioning system.

FIG. 2 is a schematic cross-sectional view of an example air treatment module.

FIG. 3 is a cross-sectional view of an example adsorbent media bed and photocatalyst.

FIG. 4 is a schematic cross-sectional view of another example air treatment module.

FIG. 5 is a perspective view of an example integrated gas purifier.

### DETAILED DESCRIPTION OF THE PREFERRED EMBODIMENT

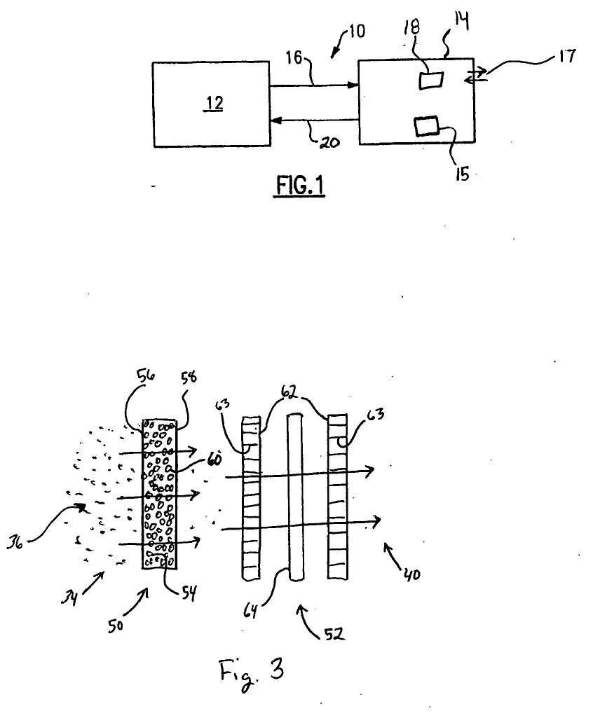

FIG. 1 illustrates a structure 10, for example a residential, commercial, or vehicular structure, which includes an interior space 12, such as a room, office, or vehicle cabin. A heating, ventilating, and air conditioning (HVAC) system 14 selectively heats or cools the interior space 12 based upon a user input into the HVAC system 14. An air-moving unit 15, for example a fan, blower, and/or compressor, moves air into the HVAC system 14 from the interior space 12 of the structure 10 through an inlet path 16, and a ventilation portion 17 allows transfer of air between the HVAC system 14 and an outside atmosphere.

The HVAC system 14 includes an air treatment module 18 that purifies the received air. The air-moving unit 15 then returns the purified air to the interior space 12 through an outlet path 20. The terms “purify,” “purified,” and variations thereof used in this description refer to removing, decontaminating, chemically converting, or otherwise making the air free of contaminants such as dust, volatile organic compounds (VOCs), biological compounds, or other contaminants.

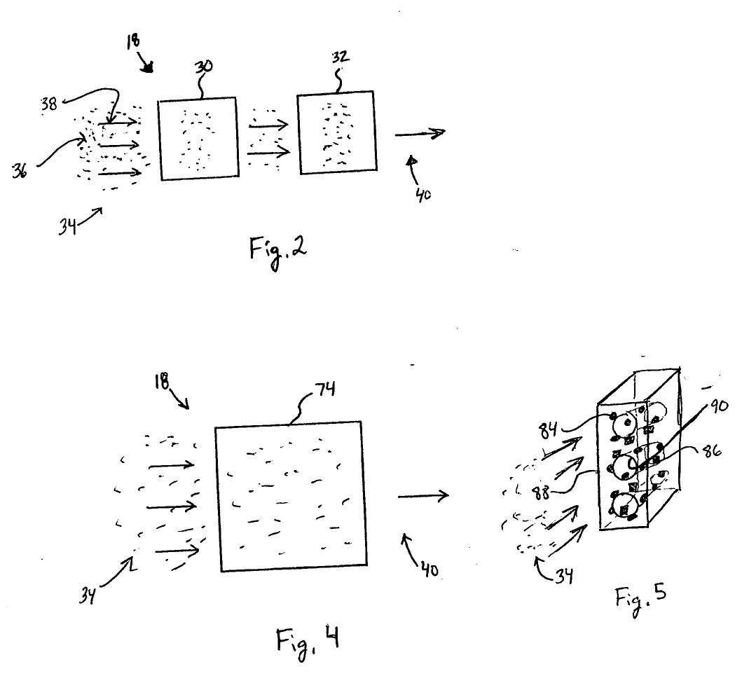

FIG. 2 is a schematic cross-sectional view of an example air treatment module 18 of the HVAC system 14 of FIG. 1. The air treatment module 18 includes a first gas purifier 30 and a second gas purifier 32 in fluid communication with the inlet path 16 (FIG. 1) such that the first gas purifier 30 and second gas purifier 32 receive the air in the form of a gas stream 34 through the inlet path 16 from the interior space 12.

One example gas stream 34 includes a concentration of contaminants 36 in an incoming portion 38 of the gas stream 34. The source of contaminants 36 is a short-term condition in the interior space 12, such as an alcohol spill or the presence of foods and beverages. The first gas purifier 30 and second gas purifier 32 cooperatively control the concentration of contaminants 36 such that the concentration of the contaminants 36 in an outgoing portion 40 of the gas stream 34 is maintained with a selected concentration range.

In one example, the concentration of contaminants 36 is equal to or greater than a threshold concentration such that neither the first gas purifier 30 nor the second gas purifier 32 alone is able to maintain the concentration of the contaminants in the outgoing portion 40 of the gas stream 34 within the selected concentration range. However, the first gas purifier 30 and second gas purifier 32 are cooperatively able to control the concentration in the outgoing portion 40 within the selected range.

In previously known air treatment systems, the concentration of contaminants 36 in an outgoing portion of a gas stream may sharply increase when a concentration of contaminants 36 temporarily exceeds the threshold concentration from a short-term event, such as an alcohol spill. However, the cooperation of the first gas purifier 30 and second gas purifier 32 may mitigate or eliminate these sharp increases in concentration.

In one example illustrated in FIG. 3, the first gas purifier 30 includes an adsorbent media bed 50 arranged in series with the second gas purifier 32, which includes a known photocatalyst 52. The adsorbent media bed 50 adsorbs contaminants from the gas stream 34. One example adsorbent media bed 50 includes an adsorbent media 54 between first and second screens 56, 58. The photocatalyst 52 chemically converts contaminants 36, for example into more environmentally acceptable chemical compounds.

One example known photocatalyst 52 includes a titanium dioxide catalyst 62 supported on a honeycomb 63, and an ultraviolet light source 64 that illuminates and activates the catalyst 62 to chemically convert the contaminants 36. The photocatalyst receives the gas stream 34 and contaminants 36, which flow through the honeycomb 63. When the ultraviolet light source 64 illuminates the catalyst 62, photons of the ultraviolet light are absorbed by the titanium dioxide to promote an electron from the valence band to the conduction band and thus produce a hole in the valence band. The promoted electron reacts with oxygen, and the hole remaining in the valence band reacts with water, forming reactive hydroxyl radicals. When contaminants 36 in the gas stream 34 flow through the honeycomb 63 and are adsorbed onto the titanium dioxide catalyst 62, the hydroxyl radicals attack and oxidize the contaminants 36 to water, carbon dioxide, or other substances.

In another example adsorbent media bed 50, the adsorbent media 54 adsorbs contaminants 36 from the gas stream 34 as the gas stream 34 passes over the adsorbent media 54. That is, the adsorbent media 54 retains contaminants from the gas stream 34 by adsorptively capturing the contaminants 36 on surfaces 60 of the adsorbent media 54.

In one adsorbent media 54 example, the type of adsorbent media 54 is selected from a zeolite, activated carbon, an aluminum-containing media, or a titanium-containing media.

As is known, adsorbent media 54 adsorbs or desorbs the contaminants 36 depending on the concentration of the contaminants 36 in the gas stream 34 relative to an equilibrium concentration of the contaminant 36 on the surfaces 60. When the contaminant 36 concentration is higher than the equilibrium concentration, the contaminant will adsorb on to the surfaces 60. Conversely, when the contaminant 36 concentration is lower than the equilibrium concentration, the contaminant will desorb from the surfaces 60.

The rate of adsorption or desorption of the contaminant 36 is proportional to the difference between the contaminant 36 concentration and the equilibrium concentration and depends, for example, on temperature and the magnitude of the difference between the contaminant 36 concentration and the equilibrium concentration. The processes of adsorption and desorption by adsorbent media 54 varies continuously in magnitude as a function of the difference between the contaminant 36 concentration and the equilibrium concentration. The rate of absorption (or desorption) of a contaminant by or from the absorbent media 54 depends, among other things such as temperature, on the magnitude and relative sign (+ or −) of the difference between the contaminant 36 concentration in the gas phase relative to the equilibrium concentration of the contaminant 36 on the surface 60 of the media 54.

In another example, the adsorbent media 54 includes at least two different types of adsorbent media. One possible benefit associated with utilizing at least two different types of adsorbent media is producing a desired adsorptive affinity of the adsorbent media bed 50. The term “adsorptive affinity” used in this description refers to the tendency of the adsorbent media 54 to retain or release particular types of contaminants 36. That is, an adsorbent media 54 having a high adsorptive affinity for a particular type of contaminant 36, such as an alcohol based contaminant 36, tends to favor retaining that particular type of contaminant 36 over releasing the contaminant 36 under a normal gas stream 34 condition (i.e. generally constant flow and generally constant non-elevated contaminant concentrations). An adsorbent media 54 having a low adsorptive affinity for a particular type of contaminant tends not to retain a significant amount of that type of contaminant and tends to easily release amounts that are retained under the normal gas stream 34 condition.

Different types of adsorbent media 54 have different adsorptive affinities for different types of contaminants 36. In one example, a zeolite media has a high affinity for adsorbing water and a lower affinity for adsorbing hydrocarbons. An activated carbon media has a high affinity for adsorbing hydrocarbons and a lower affinity for adsorbing water. A mixture of different types of adsorbent media 54, for example, a zeolite media and an activated carbon media, produces a composite adsorbent media 54 having an adsorptive affinity that corresponds to the ratio of the different types of adsorbent media 54 in the mixture. An example 1:1 ratio mixture of zeolite and activated carbon adsorbent media compositely has a medium affinity for hydrocarbons and water, which is one example desired adsorptive affinity of the adsorbent bed 50.

Other examples may include other types of adsorbent media 54, a different ratio, and/or more than two different types of adsorbent media 54 to achieve other desired adsorptive affinities, such as a desired adsorptive affinity that is selected for a specific type of contaminant 36. The specific type of contaminant may include, for example, a hydrocarbon, water, alcohol, or aldehyde. This may provide the benefit of controlling the concentration of the specific contaminant 36 in the gas stream 34 when there is competition among different types of contaminants 36, including the specific contaminant 36, for active catalyst sites in the photocatalyst 52.

In another example, the adsorbent media 54 retains at least a portion of the contaminants 36 when the concentration of the contaminants 36 in the incoming portion 38 of the gas stream 34 is equal to or greater than the threshold concentration. Later, when the concentration is less than the threshold concentration, the adsorbent media gradually releases the retained contaminants either into the outgoing portion 40 of the gas stream 34 (when the adsorbent media bed 50 is arranged downstream from the photocatalyst 52) or to the photocatalyst 52 for chemical conversion (when the adsorbent media bed 50 is arranged upstream from the photocatalyst 52). That is, above the threshold concentration the adsorbent media 54 predominantly adsorbs contaminants 36 and below the threshold concentration the adsorbent media 54 predominantly desorbs contaminants 36.

This feature may beneficially allow the adsorbent media bed 50 and photocatalyst 52 to cooperatively control the concentration of contaminants 36 in the outgoing portion 40 of the gas stream 34 when the concentration in the incoming portion is equal to or greater than the threshold concentration.

In another example, the threshold concentration exceeds a gas-purifying capacity of the photocatalyst 52. The gas-purifying capacity is a concentration above which the photocatalyst is incapable of chemically converting contaminants 36. Alternatively, the gas-purifying capacity may be associated with a gas-purifying efficiency, which is the percentage of contaminants 36 out of all of the contaminants 36 that are received by the photocatalyst 52 that are completely chemically converted. Without the adsorbent media bed 50, an excess of contaminants 36 that are above the gas-purifying capacity would pass through the photocatalyst 52, into the outgoing gas stream 40, and back into the interior space 12 without first being chemically converted. However, in an arrangement with the adsorbent media bed 50, the adsorbent media bed 50 acts as a buffer by retaining at least a portion of the contaminants 36 and maintaining the concentration of contaminants 36 received into the photocatalyst 52 below the gas-purifying capacity over the duration of time that the concentration exceeds the threshold concentration. The adsorbent media bed 50 then gradually releases the retained contaminants 36 to the photocatalyst 52 for chemical conversion when the concentration of contaminants 36 in the gas stream 34 is less than the threshold concentration.

FIG. 4 is a schematic cross-sectional view of another example air treatment module 18 of the HVAC system 14 of FIG. 1. The air treatment module 18 includes an integrated first and second gas purifier 74. That is, the first gas purifier 30 and the second gas purifier 32 of FIG. 2 are integrated into a single unitary structure.

In one example integrated first and second gas purifier 74 illustrated in FIG. 5, an adsorbent media 84 and a catalyst material 86 are deposited onto a honeycomb structure 88 such that the gas stream 34 can flow through the honeycomb openings 90 and contact the adsorbent media 84 and a catalyst material 86. In addition to other benefits mentioned above, the integrated first and second gas purifier 74 may also provide a more compactly-sized air treatment module 18.

The air treatment modules 18 of the present examples therefore provide control over the concentration of contaminants 36 in the outgoing gas stream 40 when the concentration of the contaminants 36 in the incoming gas stream 38 temporarily exceeds a threshold concentration.

Although a preferred embodiment of this invention has been disclosed, a worker of ordinary skill in this art would recognize that certain modifications would come within the scope of this invention. For that reason, the following claims should be studied to determine the true scope and content of this invention.

We claim:

1. A gas treatment module comprising:
first and second gas purifiers arranged in fluid communication with each other, and the first gas purifier temporarily retains at least a portion of contaminants in a gas stream when a concentration of the contaminants is greater than or equal to a threshold concentration and later releases at least a portion of the retained contaminants to the second gas purifier when the concentration is less than the threshold concentration.

2. The module as recited in claim 1, wherein the first and second gas purifiers maintain the concentration of contaminants in the outgoing portion of the gas stream within a selected concentration range during a time when the concentration of the contaminants in the incoming portion of the gas stream temporarily exceeds the threshold concentration.

3. The module as recited in claim 2, wherein each of the first and second gas purifiers alone is unable to maintain the concentration of contaminants in the outgoing portion of the gas stream within the selected concentration range.

4. The module as recited in claim 2, wherein the first gas purifier temporarily maintains the concentration of contaminants in the gas stream below a gas-purifying capacity of the second gas purifier when the threshold concentration temporarily is greater than the gas-purifying capacity to control the concentration in the outgoing portion of the gas stream.

5. The module as recited in claim 1, wherein the first gas purifier gradually releases the retained contaminants when the concentration is less than the threshold concentration.

6. The module as recited in claim 1, wherein the first gas purifier includes an adsorbent media and the second gas purifier includes an oxidative reactor, and said adsorbent media adsorbs the contaminants to retain the contaminants and desorbs the contaminants to release the contaminants to said oxidative reactor.

7. The module as recited in claim 1, wherein the first gas purifier includes a catalyst and the second gas purifier includes an adsorbent media, and said catalyst adsorbs at least a portion of the contaminants on a surface of the catalyst and chemically converts the adsorbed portion of the contaminants into other chemical compounds.

8. A gas treatment module comprising:
an adsorbent media that temporarily retains at least a portion of contaminants in a gas stream when a concentration of the contaminants is greater than or equal to a threshold concentration, and the adsorbent media later releases at least a portion of the retained contaminants when the concentration is less than the threshold concentration;
a reactor in fluid communication with said adsorbent media, said adsorbent media cooperating with said reactor to control the concentration of contaminants in an outgoing portion of the gas stream.

9. The module as recited in claim 8, wherein said adsorbent media includes a plurality of different types of adsorbent media.

10. The module as recited in claim 9, wherein said plurality of different types of adsorbent media includes at least one of a zeolite, activated carbon, a titanium-based, silica gel, activated clay, or an aluminum-based adsorbent media.

11. The module as recited in claim 8, wherein said absorbent media and said reactor are integrated in a single unitary structure.

12. The module as recited in claim 8, wherein said reactor includes a gas-purifying capacity and the threshold concentration exceeds said gas-purifying capacity.

13. The module as recited in claim 8, wherein said reactor includes a catalyst that receives the released contaminants and chemically converts at least a portion of the released contaminants.

14. The module as recited in claim 8, wherein said adsorbent media is arranged downstream from said reactor, and said retained contaminants that said adsorbent media retains are received from said reactor.

15. The module as recited in claim 8, wherein said adsorbent media gradually releases the retained contaminants when the concentration is less than the threshold concentration.

16. A method of gas treatment comprising:
controlling a concentration of contaminants in an outgoing portion of a gas stream when the concentration of the contaminants in an incoming portion of the gas stream temporarily exceeds a threshold concentration.

17. The method as recited in claim 16, including temporarily retaining contaminants when the concentration in the incoming portion of the gas stream temporarily is greater than or equal to the threshold concentration, releasing the retained contaminants when the concentration is less than the threshold concentration, and maintaining the concentration of contaminants in the outgoing portion within a selected concentration range.

18. The method as recited in claim 17, including gradually releasing the retained contaminants and chemically converting the released contaminants before the released contaminants pass into the outgoing portion of the gas stream.

19. The method as recited in claim 16, including chemically converting a portion of the concentration of contaminants, temporarily retaining a remaining portion of the concentration of contaminants, and later releasing the remaining portion when the concentration does not exceed the threshold concentration to maintain the concentration of contaminants in the outgoing portion within a selected concentration range.

20. The method of claim 16, including controlling the concentration of contaminants in the outgoing portion of the gas stream when the threshold concentration exceeds a purifying capacity of at least one gas purifier in the gas stream.
